(19) United States
(12) Patent Application Publication
(10) Pub. No.: US 2016/0232242 A1
(43) Pub. Date: Aug. 11, 2016

(54) Method And System For Referral Reciprocity

(71) Applicant: Firminabox.com IP LLC, Newark, NJ (US)

(72) Inventors: Lawrence John Friscia, III, Newark, NJ (US); Alwin Tong, Sunnyside, NY (US); Amer J. Hanini, Newark, NJ (US)

(21) Appl. No.: 14/617,147

(22) Filed: Feb. 9, 2015

(51) Int. Cl. G06F 17/30; H04L 12/58; H04L 29/08

(52) U.S. Cl. CPC G06F 17/30867; H04L 67/18; H04L 51/08; G06F 17/3053; G06F 17/3087

(57) ABSTRACT

The present disclosure describes a system, method, and non-transitory computer readable medium for providing referral services that includes a processor and a memory that has a database of service provider candidates. The database may include both featured service provider candidates and general service provider. In this regard, the present disclosure describes receiving a request for a service. After receiving a request for the service, the present disclosure may then query the database to determine a subset featured service provider candidates and a subset of general service provider candidates that match the request. The present disclosure selects a featured service provider candidate from the subset of the featured service provider candidates and a general service provider candidate from the subset of general service provider candidates. Accordingly, the present disclosure may output the featured service provider candidate and general service provider candidate.

### BACKGROUND OF THE INVENTION

The present application generally describes systems and methods for providing reciprocity for referral services.

The internet seems to be an ideal channel to access and disseminate professional referrals. However, in situations in which there is no reciprocity with the persons or entities with whom the referral could be shared, the sharing of such a referral fails to occur due to the absence of any incentives for the party to share the referral. In other words, non-reciprocity in the context of referring creates a fundamental obstacle to the development of a referral network/service. Consequently, the internet's potential to facilitate the dissemination of referrals is not realized. In this regard, the participants of a referral network/service do not have any incentive to populate the system with referrals since such behavior fails to be rewarded. Thus, referral services suffer from a “free rider” problem where some professionals benefit greatly by putting very little into the system while other professionals receive no benefit although they greatly contribute to the referral service. In other instances, certain referral services have tried to remedy this problem by ensuring that those who contribute the most receive the most out of the service. However, such services suffer from a lack of incentive for the vast majority of professionals where a small number of professionals, who refer the largest number of referrals into the system, receive most, if not all, of the referrals out of the system. In this regard, professionals have little incentive in either type of service to provide referrals due to the low likelihood that they would receive any referrals out of the service.

### BRIEF SUMMARY OF THE INVENTION

The present invention generally relates to a referral service having a built-in incentive structure whereby a professional seeking referrals can obtain such referrals through either a random selection process (e.g., as a general service provider, discussed below) or a more focused selection process (e.g., a featured service provider, discussed below). As such, professionals have an incentive to utilize the referral service even if they do not provide referrals to the service, and further, have an additional incentive to populate the service through increased opportunities to obtain referrals from the service. In other words, the referral service of the present invention, while providing a randomized incentive to professionals for joining the service, also includes a positive feedback loop to such professionals whereby the increased likelihood of receiving a positive result (e.g., obtaining a referral) incentivizes a professional to populate the service with referrals, which in turn increases the likelihood of receiving a positive result.

In one embodiment, a system for providing referral services includes a memory that has a database of service provider candidates. The database may include both featured service provider candidates and general service provider candidates. Candidates. Additionally, the system may be configured to receive a request for a service. After receiving a request for the service, the system may then query the database to determine a subset of featured service provider candidates and a subset of general service provider candidates that match the request. The system may then select a featured service provider candidate from the subset of the featured service provider candidates and a general service provider candidate from the subset of general service provider candidates. Accordingly, the system may output the featured service provider candidate and general service provider candidate.

According to some embodiments, the request may be received from a user of a referral service, and may include at least one of a type of service and a geographical location of a requester. Additionally, a referral-worthy score of the user may be increased for entering the request into the referral service.

In further embodiments, selecting the featured service provider candidate is based on at least one of a referral-worthy score, firm information, address information, significant cases, connections, languages, education, associations, or licensure. The general service provider candidate may be selected based on at least one of firm information, address information, significant cases, connections, languages, education, associations, or licensure.

In other embodiments, the processor may provide the one featured service provider candidate and the general service provider candidate via email. Additionally, the processor may receive a selection of a service provider from the featured service provider candidate and the general service provider candidate and notify the requester and the selected service provider via email.

In further embodiments, the processor may request feedback, such as via a web survey, from the requester for the selected service provider and receive feedback from the requester indicating a status of the work.

According to another embodiment, the present disclosure describes a method for providing referral services that includes receiving a request for a service and querying a database to determine a plurality of featured service provider candidates and a plurality of general service provider candidates that match the request. The method may include selecting one featured service provider candidate and one general service provider candidate and outputting the selected featured service provider candidate and general service provider candidate. Outputting the selected featured service provider candidate and general service provider candidate may be done via email.

The request may be received from a user of a referral service, and may include at least one of a type of service and a geographical location of a requester. The method may include increasing a referral-worthy score of the user for entering the request into the referral service.

According to some embodiments, the method may include receiving a selection of a service provider from the featured service provider candidate and the general service provider candidate and notifying the requester and the selected service provider via email.

The method may also include requesting feedback, via an email or web survey, from the requester for the selected service provider after the work has been completed. Accordingly, the received feedback may indicate a status of the work.

According to another embodiment, the present disclosure may include a non-transitory computer-readable medium that includes computer program instructions. The instructions may cause the processor to perform a method that includes receiving a request for a service and querying a database to determine a plurality of featured service provider candidates and a plurality of general service provider candidates that match the request. The method may include selecting one featured service provider candidate and one general service provider candidate and outputting the selected featured service provider candidate and general service provider candidate.

### BRIEF DESCRIPTION OF THE DRAWINGS

FIG. 1 illustrates one example of the system;

FIGS. 2A and 2B show an example of the system selecting service provider candidates;

FIGS. 3A and 3B illustrate examples of the result page;

FIG. 4 shows a flowchart for providing referrals;

FIG. 5 shows a flowchart for modifying the referral-worthy score of a professional; and

FIG. 6 shows a flowchart for processing feedback related to the work performed.

### DETAILED DESCRIPTION

The present disclosure relates to providing referral services and, in particular, to providing incentives to professionals to use the referral service. In this regard, a professional, such as a doctor, lawyer, engineer, etc., may register for the referral service by creating an account. Creating an account may include creating a public profile page that includes information about the services provided by the professional, the professional's geographic location, etc. Accordingly, professionals may obtain referrals and be referred to individuals seeking their services by creating an account with the referral service. While a referral service for professionals will be the primary example used throughout this disclosure, it should be understood that such a service could be used for sales leads or other professions that rely on referrals.

In this regard, professionals may subsequently receive a request from a requester (e.g., a patient, a client, etc.) for a service that the professional does not provide. For example, a general practitioner may have a patient requesting a referral for a gastroenterologist, or a corporate attorney may receive a request from a client for a personal injury attorney. Accordingly, the general practitioner or corporate attorney may access the referral service, either through their account or as a guest, and provide search criteria, such as the practice area sought and the geographic location of the requester, to obtain a referral for someone who performs the requester's service.

Continuing with this example, the referral service may then use the search criteria to query a plurality of databases. As discussed in greater detail below, one such database may constitute “general service provider candidates.” This database is populated from a variety of sources including, for example, service providers who have accessed the referral service in the past and may or may not have created an account, service providers obtained from third-party databases, such as association lists, medical boards, state bar memberships, or other databases publicly available, or the like. Another such database, also discussed further below, may constitute “featured service provider candidates.” Service providers can be included in this “featured” database by, for example, creating an account with the referral service and adding referral queries to the referral service, obtaining good feedback on previous work performed through the referral service, and/or bringing other additional service providers to the referral service, or the like. Further, the plurality of databases may include a first database of featured service providers and a separate second database of general service providers. Alternatively, the referral service may include a single database that includes both general service providers and featured service providers. Regardless of the actual organization of the service providers, the referral service may generate at least two lists: an organic candidate list taken from a pool of general service providers and a featured candidate list taken from the pool of featured service providers.

The account of a service provider who has registered with the referral service may include a profile page, which includes additional information about the service provider candidate. Such information can be accessed upon running a search through the databases following a request for services being inputted into the system.

After the request is inputted into the system, the system generates the organic candidate list and the featured candidate list which may constitute, for example, those providers that match the location and subject matter specifications of the request. The referral service may then select at least one user profile from the organic candidate list and at least one user profile from the featured candidate list to display to the professional on a results page. Alternatively, the referral service may send an electronic message (i.e., e-mail, SMS, etc.) with the at least one user profile from the organic candidate list and the at least one user profile from the featured candidate list to the professional. The electronic message may include an abstract of each of the at least one user profile from the organic candidate list and the at least one user profile from the featured candidate list. In some embodiments, the electronic message may provide a link to a webpage providing the at least one user profile from the organic candidate list and the at least one user profile from the featured candidate list. It should be noted that the featured service providers may be highlighted on the results page, or alternatively, the professional who made the request may have no knowledge of which of the service providers on the results page are featured and which are general.

The professional may then select one of the at least one user profile from the organic candidate list or at least one user profile from the featured candidate list (or a candidate from the combined list) to provide to the requester. Based on the selection of a service provider by the professional, the referral service may provide notification to the requester, the selected service provider, the professional, or any combination thereof of the project. In some examples, the notification may be an electronic message that includes the contact information of the selected candidate and the requester.

After the professional selects a service provider for the requester, the referral service may increase a referral-worthy score of the professional for providing a lead to the referral service. As the professional's referral-worthy score increases, the chances of the professional's profile being displayed on the featured candidate list in the future also increases.

Further, the referral service may request feedback from the professional making the request, the selected service provider and/or the person for whom the request was made after a predetermined period of time (i.e., a few weeks, a month, several months, etc.). In some examples, the referral service may send an electronic message to any of the professional, the selected service provider and the person for whom the request was made with a survey about topics such as the work performed, their experience using the referral service, or any combination thereof. Alternatively, the electronic message may include a link to provide feedback. Accordingly, the referral service may modify (i.e., increased/decreased) the referral-worthy score of the selected service provider based on the received feedback.

In light of the above example, the present invention generally relates to a referral service having a built-in incentive structure whereby a professional seeking referrals can obtain such referrals through either a random selection process (e.g., the general service provider database) or a more focused selection process (e.g., the featured service provider database). As such, professionals that would consider using such a referral service would recognize that, even by just signing up for the service (or otherwise being accessible by the service), the professional may obtain a referral from the system through the general service provider database. Further, such a professional also has an added incentive to utilize the referral service by, for example, creating an account and populating the service with leads and/or performing services and obtaining positive feedback to move into the featured service provider database. Since the featured service provider database necessarily includes fewer professionals, by virtue of the need for a referral-worthy score, the professionals in the featured service provider database may be selected more often for the results page. In other words, the referral service of the present invention, while providing a randomized incentive to professionals for joining the service (or being accessible by the service), also includes a positive feedback loop to such professionals whereby the increased likelihood of receiving a positive result (e.g., obtaining a referral) by being in the featured service provider database incentivizes a professional to populate the service with referrals, to remain in the featured service provider database, which in turn increases the likelihood of receiving a positive result.

Similarly, the referral service provides a positive feedback loop for the referral community overall. As professionals utilize the system and begin to receive positive results from the system, such professionals continue to input new referrals into the system. And further, other professionals will learn of the system, observe the success of the system, and decide to join the system themselves. Such learning of the system can come through standard methods of communication, or alternatively, through receiving a referral due to being included in the general service provider database (for example, by being accessible by the system from a third party database). Thus, these new professionals will input their own referrals into the system, resulting in a positive feedback loop to the professional community as a whole.

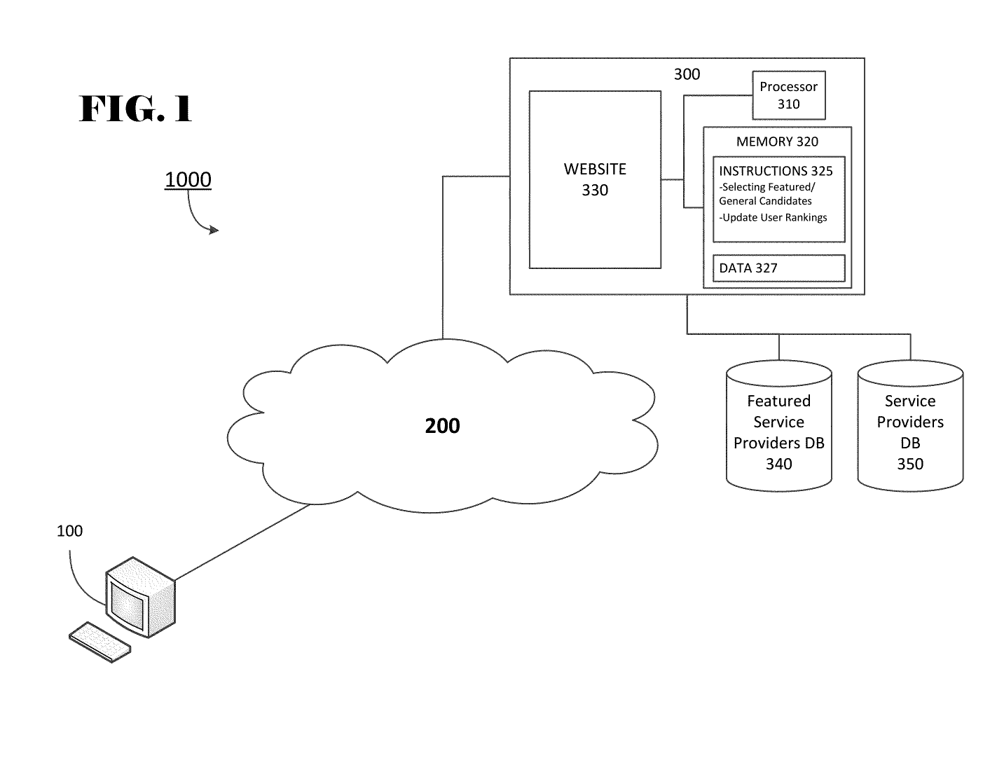

FIG. 1 illustrates one embodiment of a system 1000 according to one example of the present disclosure. Such a system 1000 may be used to perform the above exemplary process of the present invention. The system 1000 includes a computing device 100, a network 200, a server 300, a first database 340 of featured service provider candidates, and a second database 350 of general service provider candidates. The computing device 100 may be any type of computing device capable of accessing server 300 via network 200. In this regard, the computer device 100 may include a server, a server farm, a desktop computer, a laptop, a smart phone, a tablet, a virtual desktop, etc. Although only one computing device 100 is shown in FIG. 1, one of ordinary skill in the art would recognize that multiple computing devices of varying types may access the server 300.

The network 200 may include the Internet, the World Wide Web, intranets, virtual private networks, local Ethernet networks, private networks using communication protocols proprietary to one or more companies, leased lines, cellular networks (i.e., LTE, GSM, etc.), wireless networks (e.g., WiFi), data center networks, a circuit-switched network, a packet-switched network, or various combinations of the foregoing.

The server 300 may be any computing device capable of hosting a referral service. In this regard, the server 300 may be located in a server farm or data center. Alternatively, the server 300 may be a third party server providing the referral service as a Software as a Service (SaaS).

The server 300 includes a processor 310 and a memory 320 interconnected via a bus. The server 300 may also host a website 330. The processor 310 may be any conventional processor. Alternatively, the processor 310 may be a dedicated controller, such as a Field Programmable Gate Array (FPGA) or an Application Specific Integrated Circuit (ASIC). In some examples, the processor 310 may include multiprocessors, multicore processors, virtual processors, or any combination thereof.

The memory 320 stores information, such as instructions 325 and data 327, that is accessible by processor 310 via the bus. The memory 320 may be any type of computer-readable medium capable of storing information that is executable, or otherwise capable of being used, by the processor 310. In this regard, the computer-readable medium may store information that may be read with the aid of an electronic device, such as a hard-drive, memory card, flash drive, ROM, RAM, DVD or other optical disks, as well as other write-capable and read-only memories. Additionally, memory 320 may include short term or temporary storage, as well as long term or persistent storage. Alternatively, memory 320 may include an array of computer-readable media, such as a storage area network (SAN) or a RAID array, capable of being accessed by the processor 310. The systems and methods described herein may include different combinations of the foregoing, such that different portions of the instructions and data may be stored on different types of computer-readable media.

The instructions 325 may be any set of instructions to be executed by the processor 310. In this regard, the instructions may include machine code, scripts, object-oriented code capable of being executed by the processor, or any other computer based code or collections of independent source code modules that are interpreted on demand or compiled in advance. Functions, methods and routines of the instructions will be explained in greater detail below. Moreover, the term “instructions” may be used interchangeably with “programs,” “modules,” or “units.”

The data 327 may be any information capable of being retrieved, stored or modified by processor 310 according to the instructions 325. For example, the data may be stored in a database, a table having a plurality of different fields and records, XML documents, or flat files. The data may also be formatted in any computer-readable format.

The website 330 may be a referral service. In this regard, the website 330 may be a web page that provides a front end interface for the referral service. Alternatively, the website 330 may be a portal to provide the referral service as a SaaS. Accordingly, the instructions and data for rendering the website may be stored in the memory 320 and executed by the processor 310.

In operation, the server 300 may be adapted to receive a request for a service provider. In response to receiving the request, the server may query at least one database to determine a plurality of featured candidates and a plurality of general candidates that match the request. Accordingly, the server 300 may select at least one featured candidate and at least one general candidate from the plurality of general candidates. Server 300 may display the at least one featured candidate and the at least one general candidate via the webpage 330. Additionally, the server may be adapted to increase a referral-worthy score of a user for entering the request into the referral service. Further the server may be adapted to receive a selection of a service provider and notify the requester and the selected service provider, for example, via email. The server 300 may be further adapted to request feedback from the requester and receive feedback indicating a status of the work. Accordingly, the server 300 may be adapted to use the feedback to adjust the referral-worthy score of the service provider.

The first database 340, of featured service providers, may be any database format capable of storing a plurality of featured service provider candidates. As noted above, featured service provider candidates may include service providers who have registered with the referral service. Additionally or alternatively, featured service providers may include service providers who have recently provided a lead into the referral service and/or obtained a positive review for a service performed. As in the above example, preferably the featured service provider database will be populated with professionals who registered with the referral service and recently provided a lead into the referral service and/or obtained a positive review for a service performed. For example, the first database 340 may be a SQL® database, an Oracle® database, or any other database capable of being indexed, queried, and/or searched. Alternatively, the first database 340 may be a table or a data array capable of being indexed, queried, and/or searched. The first database 340 may be located at a third party, separate from the server 300 or may be local to the server 300, such as in the memory 320.

The second database 350 is similar to the first database 340. However, instead of storing a plurality of featured service provider candidates, the second database 350 stores a plurality of general service provider candidates. As noted above, general service provider candidates may be professionals who have used the referral service as a guest or have registered with the referral service but not provided any referrals to the system or obtained any positive feedback from services performed. Alternatively, the general service provider candidates may include service providers obtained from a third party, such as a professional society (e.g., a state bar association, a state medical board). In this regard, the website 330 may include an application program interface (API) to access a database maintained by the third party.

While the first database 340 and the second database 350 are shown as two separate databases, one of ordinary skill in the art would recognize that the first and second databases may be combined into a single database. Further, the first database 340 and second database 350 may be local to the server 300. For example, the first and second databases may be stored in the memory 320. According to this example, the first database 340 and the second database 350 are merely illustrative of the pool of featured service provider candidates and the pool of general service provider candidates, respectively.

Service provider candidates may be considered featured candidates just by signing up for the referral service. Alternatively, service provider candidates may be considered featured service provider candidates if their referral-worthy score is above a threshold value. According to this embodiment, general service provider candidates may be service provider candidates who are below the threshold value, who are obtained from a third-party database, or who have used the referral service as a guest. The threshold value may include a number of leads a candidate has entered into the referral service, feedback received, or any combination thereof. For example, a service provider candidate may transition from a general service provider candidate to a featured service provider candidate after providing 50 leads into the referral service. Alternatively, a service provider candidate may transition from a general service provider candidate to a featured service provider candidate after receiving 25 positive reviews.

Additionally, a featured service provider candidate may transition to a general service provider candidate. For example, if a featured service provider has not provided any leads into the referral system for a certain period of time, the featured service provider may have their referral-worthy score changed. Alternatively, if the featured service provider receives a certain number of negative reviews, the featured service provider's referral-worthy score may be changed.

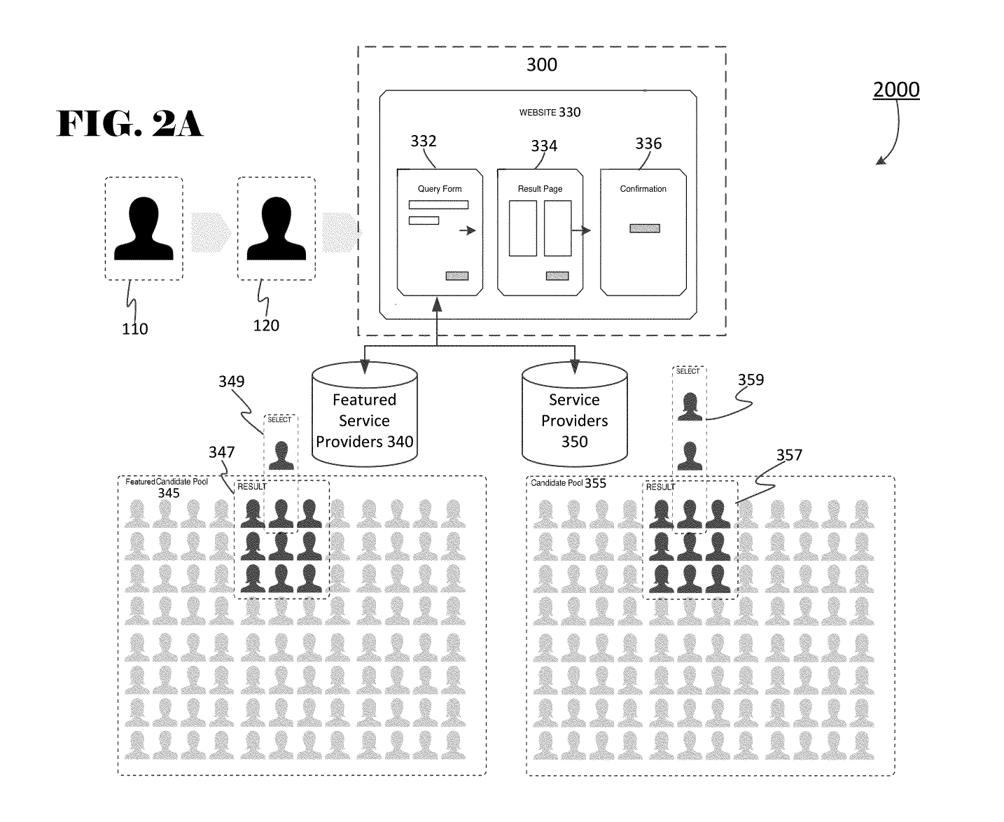

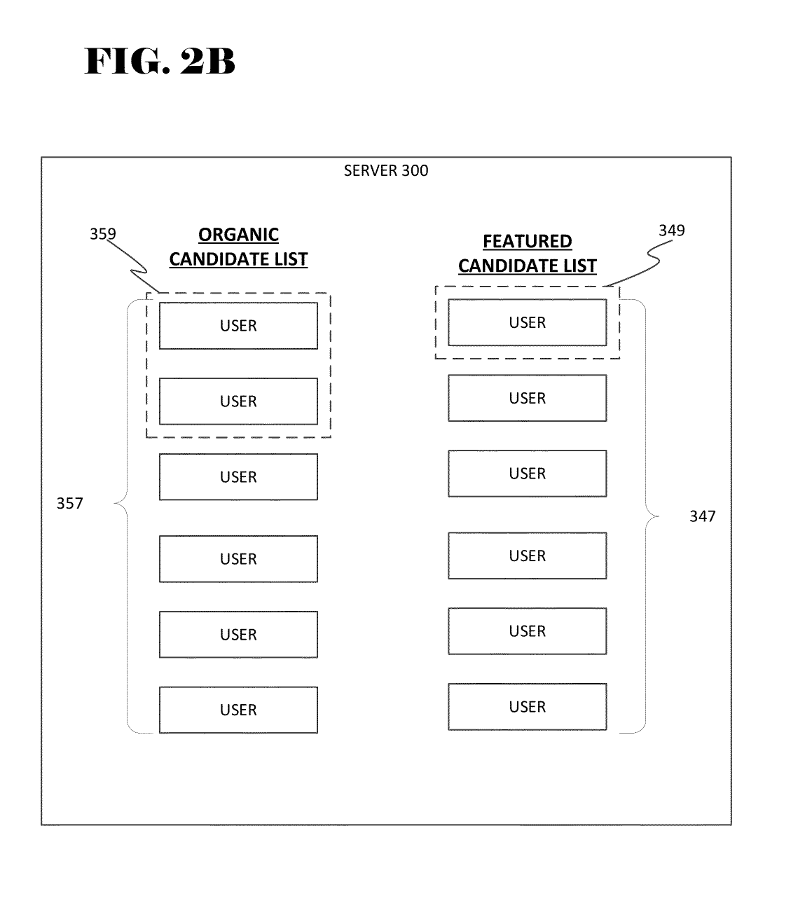

In another embodiment, FIG. 2A and 2B show an example of a system 2000 for determining at least one featured service provider and at least one general service provider to display on a results page. In this regard, the system 2000 includes a requester 110, the professional 120, the server 300, the first database 340 of featured service provider candidates, and the second database 350 of general service provider candidates.

In one example, the requester 110 may be a layperson looking for a specific service, such as an existing patient or client looking for a referral for a specialist. Alternatively, the requester 110 may be a new patient or client requesting a service from the professional 120 that is beyond the knowledge of the professional 120. In some examples, the requester 110 may be another professional seeking a referral from professional 120.

The professional 120 may be a guest accessing the referral service. Alternatively, the professional 120 may be any professional with a user profile on the referral service. The user profile may include information about professional 120 such that they are capable of being referred to people looking for referrals. In this regard, the profile information may include name, location information, licensure information, the service that professional 120 provides (i.e., medical, legal, engineering, etc.), practice areas (i.e., internist, intellectual property law, environmental engineering, etc.), and the like. Additionally, the profile may include metadata, such as the referral-worthy score, firm information, address information, significant cases, connections, languages, education, associations, whether the professional's license is up to date, registration numbers related to licensure information, etc.

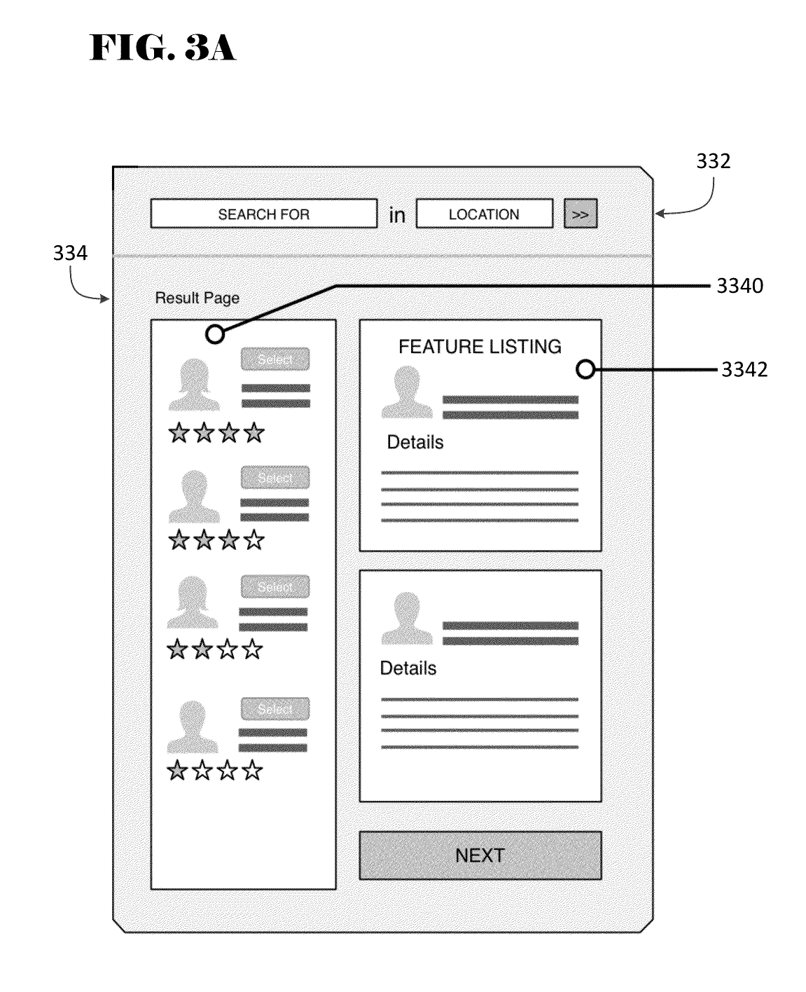

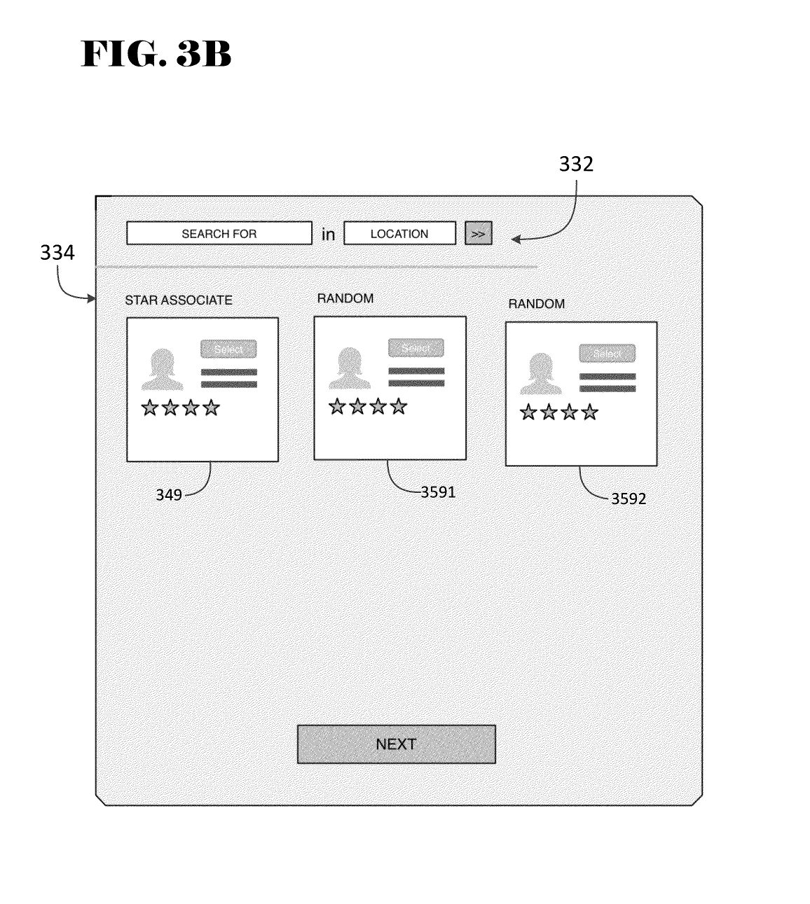

The server 300 is similar to the server discussed above that includes website 330. The website 330 may include several web pages that are accessible by professional 120. For example, website 330 may include a query form page 332, a result page 334, and a confirmation page 336. In some embodiments, the website pages may be displayed simultaneously, such as in different frames. For example, the query form page 332 and the results page 334 may be displayed together, as shown in FIGS. 3A and 3B.

The query page 332 may be capable of receiving the search criteria provided by requester 110. In this regard, professional 120 may enter the search criteria provided by requester 110 into query page 332. Alternatively, the requester 110 may access the referral service to enter the search criteria on the query page 332.

The search criteria may include a practice area, location information, cost information, preferred languages, etc. The query page 332 may also include at least one field to enter contact information of requester 110. Additionally, query page 332 may include a submit button (not shown), which will prompt the server to query the first database 340 and the second database 350.

The result page 334 may provide the results of querying the first database 340 and the second database 350. In this regard, result page 334 may provide at least one featured service provider candidate from the first database 340 and at least one general service provider candidate from the second database 350. If no service provider candidates are returned from one of the categories, result page 334 may only show results from the other category. That is, result page 334 may only show general service provider candidates if there are no featured service provider candidates meeting the search criteria. Additionally, or alternatively, result page 334 may be provided to professional 120 via an electronic message. For example, the electronic message may include the at least one featured service provider candidate and the at least one general service provider candidate, a link to the result page, or a combination of both.

Professional 120 may select one of either the featured service provider or the general service provider from result page 334. The result page will be discussed in greater detail below with respect to FIGS. 3A and 3B.

The confirmation page 336 may provide confirmation of the selected service provider. For example, confirmation page 336 may provide an indication that requester 110′s contact information has been provided to the selected service provider and vice versa. Further, confirmation page 336 may provide an indication that the selected serviced provider will contact the requester 110 within a certain amount of time.

In operation, professional 120 receives a request from requester 110 for a service provider. In this regard, the request may include search criteria, such as practice area and geographic location, which professional 120 enters into query page 332 and clicks the submit button. After clicking the submit button, the website 330 queries the first database 340 and the second database 350. As noted above, the first database 340 includes a featured service provider candidate pool 345. Similarly, the second database 350 includes a general service provider candidate pool 355. Every service provider candidate in both the first database 340 and the second database 350 includes a user profile containing at least some of the information discussed above.

In response to the search criteria provided by the website 330, first database 340 may return a set of featured service provider candidates 347 and second database 350 may return a set of general service provider candidates 357. Accordingly, the referral service may generate a featured candidate list from the set of featured service provider candidates 347 and an organic candidate list from the set of general service provider candidates 357. In some examples, result page 334 may display the featured candidate list and the general candidate list. In this regard, professional 120 may browse through all of the featured service provider candidates and the general service provider candidates.

Alternatively, the referral service may select a subset 349 of featured service provider candidates from the featured candidate list. Additionally, the referral service may select a subset 359 of general service provider candidates from the organic candidate list. The subset of featured service provider candidates and the subset of general service provider candidates may then be displayed on results page 334. In the event that a featured service provider candidate is the same as a general service provider candidate, the referral service will replace the general service provider candidate that matches the featured service provider candidate with another general service provider candidate.

The featured service provider candidates and general service provider candidates (collectively “service provider candidates”) are provided to the professional 120 according to one of the techniques discussed above. In this regard, the profiles of the service provider candidates may be browsed on result page 334. Additionally, a service provider may be selected from the service provider candidates via result page 334 by the professional 120. Professional 120 may select a service provider from the service provider candidates. The referral service may notify requester 110 and the selected service provider. Additionally, the referral service may increase the referral-worthy score of professional 120 in response to providing a lead to the referral service. Further, the website 330 may then present confirmation page 336, as discussed above.

Turning to FIGS. 3A and 3B, various examples of result page 334 are shown. Referring to FIG. 3A, result page 334 is shown, which includes query form 332 as a frame at the top of the page, an organic list of service provider candidates 3340 that satisfy the search criteria, and a featured list of service provider candidates 3342. In this regard, query form 332 may be used to search within result page 334. Alternatively, query form 332 may provide a field to perform a new service provider search.

The organic list of service provider candidates 3340 may display the results of querying the databases. The organic list of service provider candidates 3340 may include the set of featured service provider candidates 347 and the set of general service provider candidates 357. As shown in FIG. 3A, the organic list of general service provider candidates 3340 may be sorted. For example, the organic list 3340 may be sorted based on a highest-to-lowest referral-worthy score. While FIG. 3A shows sorting the organic list of general service provider candidates highest-to-lowest, one of ordinary skill in the art would recognize that any known sorting technique may be used to present the organic list of general service provider candidates 3340.

The featured list of service provider candidates 3342 may provide additional information about each of the feature service provider candidates. The additional information may include reviews, location information, licensure information, the service the professional 120 provides (i.e., medical, legal, engineering, etc.), special practice areas (i.e., internist, intellectual property law, environmental engineering, etc.), etc.

Referring to FIG. 3B, result page 334 is shown, which includes query form 332, at least one featured service provider candidate 349, a first general service provider candidate 3591, and a second general service provider candidate 3592. In this regard, a user can peruse through both the featured and general service provider candidates together. Further, this variation of result page 334 may better mask the featured service provider candidate 349 relative to the general service provide candidates 3591, 3592, which may level the playing field of the general provider 3591, 3592 versus the featured candidate 349.

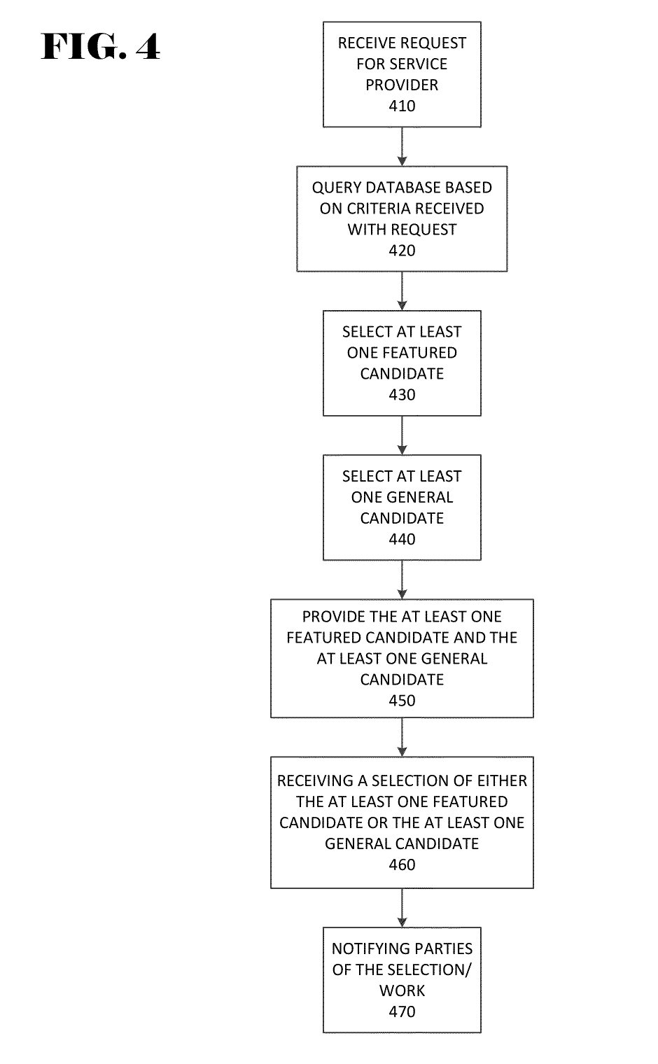

FIG. 4 shows a flowchart according to one embodiment of the present disclosure. In block 410, a referral service receives a request for a service provider. As discussed above, the request may include search criteria, such as a practice area and/or a geographic location. In block 420, a database is queried based on the search criteria received in block 410. At least one featured service provider candidate is selected in block 430 and at least one a general service provider candidate is selected in block 440 based on the results of the database query in block 420. The featured service provider candidate and the general service provider candidate are provided to a professional via a results page in block 450. In block 460, the referral service receives a selection of either the featured service provider candidate or the general service provider candidate. In block 470, the parties may be notified of the impending work or project.

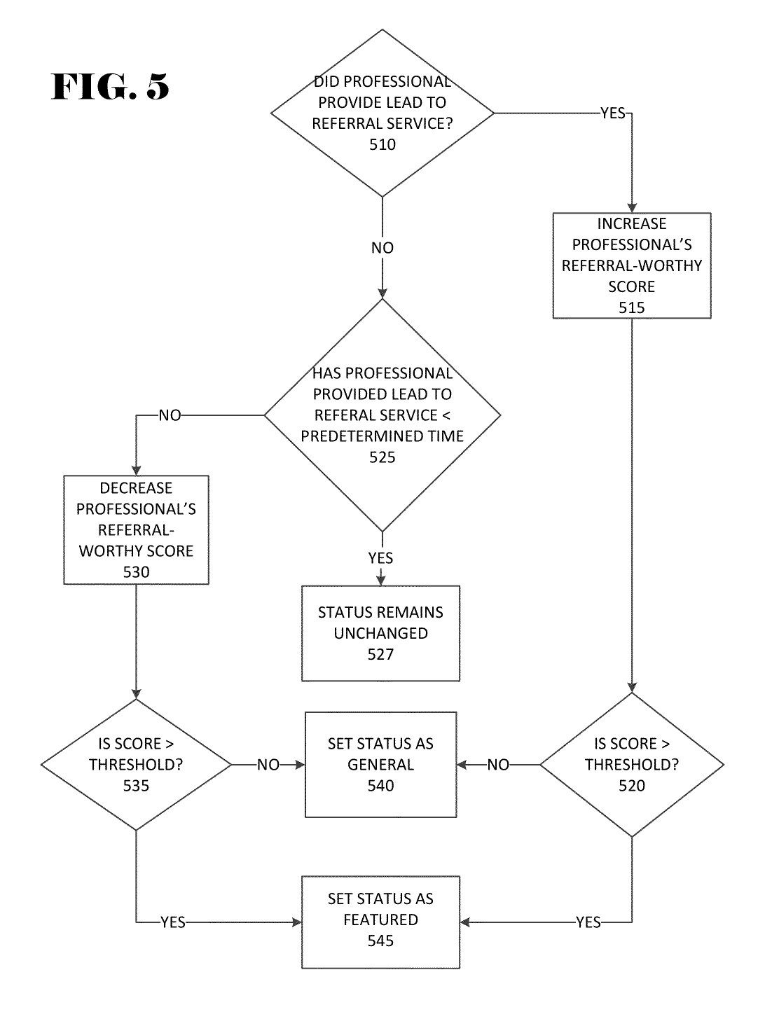

Referring to FIG. 5, one embodiment of a flowchart for modifying a professional's status as a featured or general service provider is shown. In block 510, the referral service determines whether the professional provided a lead to the referral service. If the professional has provided a lead, the referral service increases the professional's referral-worthy score in block 515. After increasing the professional's referral-worthy score, the referral service determines whether the referral-worthy score is greater than a threshold value. As discussed above, the threshold value may be a number of leads provided by the professional, a number of positive reviews, or a combination thereof. If the professional's referral-worthy score is not greater than the threshold value, the status of the professional is set as general in block 540. In this regard, the professional may remain in the pool of general service provider candidates, which may result in fewer referrals. However, if the professional's referral-worthy score is greater than the threshold, then the status of the professional is changed to featured service provider in block 545. In this regard, the professional may be moved to the pool of featured service provider candidates, which may result in more referrals and more business opportunities.

If the referral service determines that the professional has not provided a lead in block 510, the referral service determines whether the professional has provided a lead to the referral service in a predetermined amount of time (e.g., 6 months, a year, etc.) in block 525. If the professional has provided a lead within the predetermined time, the process proceeds to block 527 where the professional's referral-worthy score remains unchanged. However, if the professional has not provided a lead to the referral service in a predetermined amount of time, the referral-worthy score of the professional is decreased in block 530. The new referral-worthy score is compared to a threshold value in block 535. If the new referral-worthy score is below the threshold value, the status of the professional is set as general service provider in block 540, which would place the professional in the pool of general service provider candidates. However, if the professional's referral-worthy score is greater than the threshold, then the status of the professional is set to featured service provider in block 545, and the professional may be grouped in the pool of featured service provider candidates.

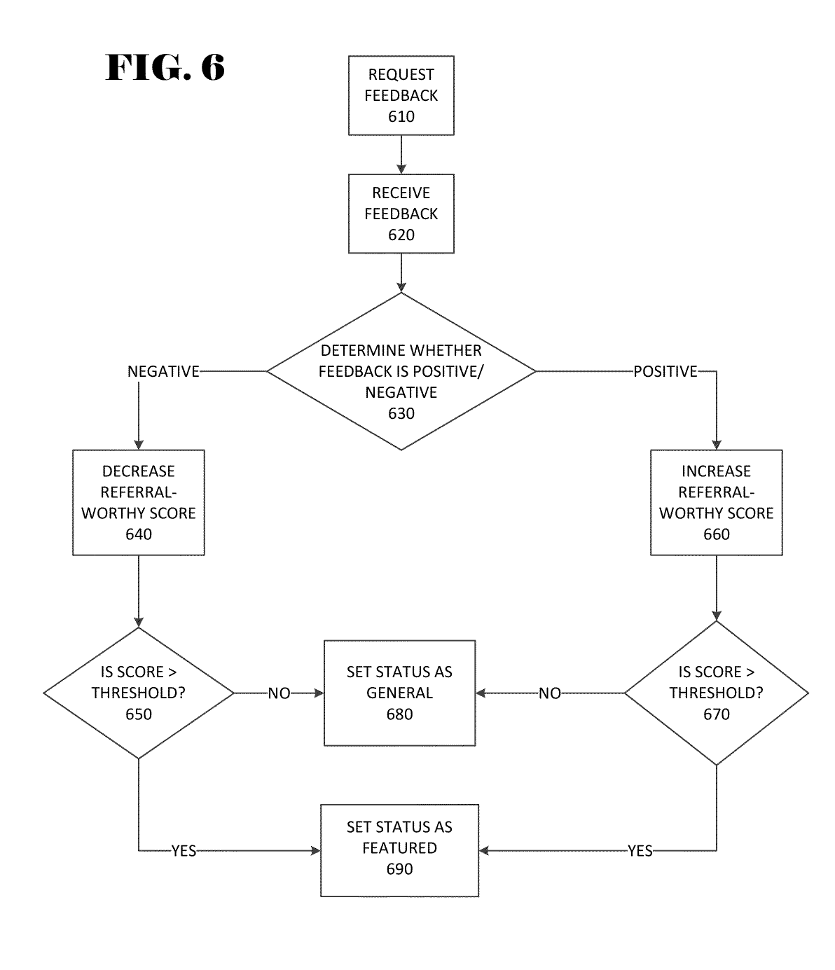

After completion of the requester's project or work, the referral service may request feedback related to the completed work. FIG. 6 shows an exemplary flowchart for processing feedback related to the completed work.

In block 610, the referral service may request feedback. In this regard, the referral service may request feedback from the requester, the professional, the service provider, or any combination thereof. The feedback may be used by the referral service to adjust the referral-worthy score of the service provider. As noted above, the feedback may be a survey provided via an electronic message or a web page.

In block 620, the referral service may receive feedback. The feedback may indicate the status of the work. For example, the feedback may indicate that the work was completed, partially completed, or abandoned (i.e. failed to be completed) by the service provider. Additionally, the feedback may indicate the requester's satisfaction with the completed work. In some examples, the feedback may include additional notes and comments that may provide additional information regarding the service provider. Accordingly, the feedback information may be used to update metadata associated with the user's profile. In particular, the feedback information may impact the user's referral-worthy score.

In block 630, the referral service determines whether the received feedback was positive or negative. If the feedback was negative, the process proceeds to block 640 which decreases the referral-worthy score of the service provider. The new referral-worthy score is compared to a threshold value in block 650. If the new referral-worthy score is below the threshold value, the status of the service provider is set as general service provider in block 680. As noted above, this may result in the service provider being placed in the pool of general service provider candidates. However, if the service provider's referral-worthy score is greater than the threshold in 650, then the status of the service provider is set to featured service provider in block 690, and the service provider may be grouped in the pool of featured service provider candidates.

Returning to block 630, if the referral service determines that the feedback is positive, then the method proceeds to block 660 to increase the referral-worthy score of the service provider. The new referral-worthy score is compared to a threshold value in block 670. If the new referral-worthy score is below the threshold value, the status of the service provider is set as general service provider in block 680, which results in the service provider being placed in the pool of general service provider candidates. However, if the service provider's referral-worthy score is greater than the threshold in 670, then the status of the service provider is set to featured service provider in block 690. Accordingly, the service provider may be grouped in the pool of featured service provider candidates, which may result in more referrals.

The following is one example of how the referral service of the present invention may be used. A corporate attorney, who is not registered with the referral service, may receive a request from a client for a criminal defense attorney in Newark, N.J. The corporate attorney may access the referral service through the website and enter the search criteria: criminal defense attorney near Newark, N.J. The referral service may then query its databases and provide a list of candidates that match the corporate attorney's search criteria of location and type of practice. The list of candidates may include featured service provider candidates and general service provider candidates. Accordingly, the corporate attorney may select a criminal defense attorney from the list of candidates and provide the information to the requesting client.

After completion of the work, the referral service may request feedback from the client, the corporate attorney, and the criminal defense attorney. As noted above, the feedback may be used to modify the referral-worthy score of the corporate attorney and/or the criminal defense attorney. Additionally, the corporate attorney and criminal defense attorney may be prompted for feedback about their experience with the referral service. Further, the criminal defense attorney may have been selected from the general service provider pool and was unaware of the referral service.

Based on their experiences with the referral service, if not already registered members, the corporate attorney and criminal defense attorney may both create accounts with the referral service. The corporate attorney would recognize the benefit of helping his clients find other professionals, and further may acknowledge the potentials leads which could come to him from the system. As to the criminal attorney, presuming he was not a registered user previously, would likewise recognize the benefits of obtaining leads through the system. Further, upon learning of the possibility of obtaining “featured” status, and the benefits conferred with such status, these professionals may provide leads into the system, which would result in a higher referral-worthy score and subsequently more incoming referrals back to them. Further, the addition of these attorneys, and the leads they provide to the system, would create a more robust network of professional service providers and thus improved referrals going into and coming out of the system.

The above-discussed methods and systems of the present invention generate a marketplace through creating scarcity in results sent to a requestor. In other words, since the results sent to the requestor are limited to a subset (e.g., at least one featured professional and at least one randomly selected professional) of the overall population in the referral service, a scarcity of results is achieved, and each professional on the service thereby has an incentive to take steps to increase the likelihood of being selected for the subset (e.g., by inputting leads into the system and/or obtaining positive reviews, or the like). Additionally, the mere presence of the professional on the service gives the professional an opportunity to obtain referrals through the random, general subset selection process. Thus, the scarcity created by the present invention incentivizes a professional to join the service and remain on the service, while providing a further incentive to populate the service with leads.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system for providing referral services comprising:
a memory containing a database of service provider candidates, wherein the database includes a plurality of featured candidates and a plurality of general candidates; and
one or more processors, operatively coupled to the memory, configured to:
receive a request for a service;
query the database to determine a subset of the plurality of featured candidates that match the request;
query the database to determine a subset of the plurality of general candidates that match the request;
select at least one featured candidate from the subset of the plurality of featured candidates; and
select at least one general candidate from the subset of the plurality of general candidates;
output the at least one featured candidate and the at least one general candidate.

2. The system according to claim 1, wherein the request for the service is received from a user of a referral service.

3. The system according to claim 2, wherein the processor is further configured to:
increase a referral-worthy score of the user of the referral service for entering the request into the referral service.

4. The system according to claim 1, wherein selecting the at least one featured candidate is based on at least one of a referral-worthy score, firm information, address information, significant cases, connections, languages, education, associations, or licensure.

5. The system according to claim 4, wherein selecting the at least one general candidate is based on at least one of firm information, address information, significant cases, connections, languages, education, associations, or licensure.

6. The system according to claim 1, wherein the request includes at least one of a type of service and a geographical location of a requester.

7. The system according to claim 1, wherein the processor is further configured to:
provide the at least one featured candidate and the at least one general candidate via email.

8. The system of claim 1, wherein the processor is further configured to:
receive a selection of a service provider from the at least one featured candidate and the at least one general candidate; and
notify the requester and the selected service provider.

9. The system of claim 8, wherein notifying the requester includes emailing the requester, the recommender, and the referral.

10. The system of claim 8, wherein after work has been completed, the processor is configured to:
request feedback from the requester for the selected service provider; and
receive feedback from the requester indicating a status of the work.

11. The system of claim 10, wherein the feedback is provided via an email survey or a web survey.

12. A method for providing referral services comprising:
receiving, at a server, a request for a service;
querying a database to determine a plurality of featured candidates that match the request;
querying the database to determine a plurality of general candidates that match the request;
selecting at least one featured candidate from the plurality of featured candidates;
selecting at least one general candidate from the plurality of general candidates;
outputting the at least one featured candidate and the at least one general candidate.

13. The method according to claim 12, wherein the request for the service is received from a user of a referral service.

14. The method according to claim 13, further comprising:
increasing a referral-worthy score of the user of the referral service for entering the request into the referral service.

15. The method according to claim 12, wherein the request includes at least one of a type of service and a geographical location of a requester.

16. The method according to claim 12, further comprising:
providing the at least one featured candidate and the at least one general candidate via email.

17. The method of claim 12, further comprising:
receiving a selection of a service provider from the at least one featured candidate and the at least one general candidate; and
notifying the requester and the selected service provider.

18. The method of claim 17, wherein notifying includes sending an email to the requester, the recommender, and the referral.

19. The method of claim 17, wherein after work has been completed, the method further comprises:
requesting feedback from the requester for the selected service provider; and
receiving feedback from the requester indicating a status of the work.

20. A non-transitory computer-readable medium storing computer program instructions, which, when executed by one or more processors, cause the processor to perform a method comprising:
receiving a request for a service;
querying a database to determine a plurality of featured candidates that match the request;
querying the database to determine a plurality of general candidates that match the request;
selecting at least one featured candidate from the plurality of featured candidates;
selecting at least one general candidate from the plurality of general candidates;
outputting the at least one featured candidate and the at least one general candidate.
